(19) United States
(12) Patent Application Publication
(10) Pub. No.: US 2008/0207131 A1
(43) Pub. Date: Aug. 28, 2008

(54) Apparatus, method and computer program product providing enhanced cognitive radio channel selection

(75) Inventor: Edmund Coersmeier, Bochum (DE)

Correspondence Address: HARRINGTON & SMITH, PC, 4 RESEARCH DRIVE, SHELTON, CT, 06484-6212, US

(73) Assignee: Nokia Corporation

(21) Appl. No.: 12/072,639

(22) Filed: Feb. 26, 2008

Related U.S. Application Data
(60) Provisional application No. 60/903,596, filed on Feb. 26, 2007.

(51) Int. Cl. H04B 15/00; H04B 17/00

(52) U.S. Cl. 455/62

(57) ABSTRACT

In a cognitive radio system, a complexity to be used for a receiver of a cognitive radio is determined, and a connection between an access node and the receiver is changed to a connection having a corresponding complexity. In one embodiment the cognitive radio itself determines the complexity and changes its connection. In another embodiment the cognitive radio sends a request to the access node which makes the change in a new resource allocation. In still another embodiment the access node determines the complexity from a transmission power change of the cognitive radio. Apparatus, methods and embodied computer programs for implementing the invention are detailed.

### CROSS-REFERENCE TO RELATED APPLICATION

This application claims priority to U.S. Provisional Patent Application No. 60/903,596, filed on Feb. 26, 2007, the contents of which are incorporated herein in its entirety.

### TECHNICAL FIELD

The exemplary embodiments of this invention relate generally to wireless communication systems and, more specifically, relate to channel selection in cognitive radio.

### BACKGROUND

The following abbreviations are utilized herein:

CDMA code division multiple access
CSI channel-state information
E-UTRAN evolved UMTS terrestrial radio access network
FIR finite impulse response
OFDMA orthogonal frequency division multiple access
RNN recurrent neural network model
SIMO single-input, multiple-output
UMTS universal mobile telecommunications system
UTRAN UMTS terrestrial radio access network

Cognitive radio refers to a principle for efficient spectrum usage. Reference with regards to cognitive radio may be made to:
Haykin, S., “Cognitive Radio: Brain-Empowered Wireless Communications”, IEEE Journal on Selected Areas in Communications, vol. 23, no. 2, pp. 201-220, February 2005, referred to herein as Haykin1.
Federal Communications Commission, “Spectrum Policy Task Force”, Rep. ET Docket No. 02-135, November 2002.
E2R Cognitive Pilot Channel, P. Cordier et al., E2R project report, 2006.
Software-Defined Radio—Basics and Evolution to Cognitive Radio, Friedrich K. Jondral, EURASIP Journal on Wireless Communications and Networking, 2005:3, pp. 275-283.
Draft Standard Definitions and Concepts for Spectrum Management and Advanced Radio Technologies IEEE P1901.1™/D01, Feb. 15, 2006 (v 0.10).
Cognitive Radio: Brain-Empowered Wireless Communications, Simon Haykin, IEEE Journal on Selected Areas in Communications, Vol. 23, No. 2, February 2005.

In the Abstract, Haykin1 states: “The cognitive radio, built on a software-defined radio, is defined as an intelligent wireless communication system that is aware of its environment and uses the methodology of understanding-by-building to learn from the environment and adapt to statistical variations in the input stimuli, with two primary objectives in mind: highly reliable communication whenever and wherever needed; efficient utilization of the radio spectrum.” This process is further described in Haykin1, with particular reference to Section B and FIG. 1 of Haykin1.

Utilizing cognitive radio principles, the radio spectrum is more efficiently utilized because a mobile terminal: scans the environment, determines the best or preferred frequency band and transmission standard and indicates said preferences by signaling the base station with the preferred transmit power, channel pre-equalization and pre-coding scheme.

As another example, a cognitive radio system: scans the frequency bands, finds free frequency space, measures and understands the channel complexity, has knowledge of its own application and, thus, its required data rate and quality of service and chooses and defines one, several or all radio layers on the fly for optimal transmission. Thus, a cognitive radio system may be capable of configuring the transmitter and receiver setup based on the system's understanding of the radio environment and application requirements.

For cognitive radio technology, a continuous pilot transmission may not be considered a reasonable way to analyze channel conditions because it is wasteful in transmit power and channel bandwidth. See Haykin1 at pp. 207 (Section VI). One alternative, proposed by Haykin2 (see citation below), is to use semi-blind training which first employs a supervised training mode and subsequently tracks the initial channel state estimation to detect changes in the channel properties.

Reference with regard to this alternative, and other aspects of a cognitive radio system, may be made to:
Haykin S., Huber K., Chen Z., “Bayesian Sequential State Estimation for MIMO Wireless Communication”, Proc. IEEE, vol. 92, no. 3, pp. 439-454, March 2004, referred to herein as Haykin2.

FIG. 1 illustrates a conventional combined supervised training and tracking mode, as further described by Haykin1 and Haykin2. As explained in Haykin1 at pp. 440 and in Haykin2 at pp. 207-208, the receiver has two modes of operation:
“(1) Supervised training mode. During this mode the receiver acquires an estimate of the channel state, which is computed under the supervision of a short training sequence (consistently of two to four symbols) known to the receiver that is sent over the channel (for a limited period) by the transmitter prior to the actual data transmission.”
“(2) Tracking mode: Once a reliable estimate of the channel state has been achieved, the training sequence is switched off, actual data transmission is initiated, and the receiver is switched to the tracking mode; this mode of operation is performed in an unsupervised manner on a continuous basis during the course of data transmissions.”

After channel-state information is available in the receiver, a so-called rate feedback is sent from the receiver to the transmitter in order to set up the data rate and transmit-power control. See Haykin1. The rate feedback is used to start planning the required transmit-power per transmitter. In a multi-transmitter scenario, it is desirable to have each data transmission achieve its target data rate. Therefore, the corresponding transmission power should be regulated.

FIG. 2 depicts a conventional two-loop setup for bandwidth allocation and transmit-power control, as proposed by Haykin1. After initial, equal power setup for all operating transmitters (Power Initialization), a first, inner loop (Loop1) iterates for all operating transmitters. In Loop1, each transmitter allocates a number of channels based on a Water-Filling approach. See Haykin1 at pp. 213-216 (Section IX). After the bandwidth allocation (Loop1) has been finalized, the transmission systems are investigated in a second, outer loop (Loop2) which also iterates for all operating transmitters. In Loop2, each transmitter determines whether its actual data rate is exceeding, matching or undershooting the target data rate. If the actual data is exceeding or undershooting the target data rate, Loop2 adjusts the transmit-power of the respective transmitter in an attempt to match the actual data rate with the target data rate.

### SUMMARY

In accordance with one embodiment of the invention is a method that includes determining a complexity to be used for a receiver of a cognitive radio, and changing a connection between an access node and the receiver to a connection having a corresponding complexity.

In accordance with another embodiment of the invention is an apparatus that includes a processor and a transmitter and a receiver. Together they are configured to determine a complexity to be used for the receiver and to change to a connection between an access node and the receiver to a connection having a corresponding complexity.

In accordance with still another embodiment of the invention is a computer readable medium embodying program instructions that are executable by a processor for executing actions directed toward determining a complexity to be used by a receiver of a cognitive radio system. In this embodiment of the invention the actions include determining a complexity to be used for a receiver of a cognitive radio, and changing a connection between an access node and the receiver to a connection having a corresponding complexity.

In accordance with yet another embodiment of the invention is an apparatus that includes processing means and radio means that together are for determining a complexity to be used for a cognitive radio receiver and for changing to a connection between an access node and the receiver to a connection having a corresponding complexity. In a particular embodiment the processing means is a processor, and the radio means includes a transmitter and a receiver.

### BRIEF DESCRIPTION OF THE DRAWINGS

In the attached Drawing Figures:

FIG. 1 illustrates a conventional combined supervised training and tracking mode for a cognitive radio system;

FIG. 2 depicts a conventional two-loop setup for bandwidth allocation and transmit-power control;

FIG. 3 illustrates three exemplary algorithm sets that may be used for three different channel property determinations in accordance with aspects of the exemplary embodiments of the invention;

FIG. 4 shows an exemplary three-loop setup for a cognitive radio system in accordance with aspects of the exemplary embodiments of the invention;

FIG. 5 shows a simplified block diagram of various electronic devices that are suitable for use in practicing the exemplary embodiments of this invention; and

FIG. 6 depicts a flowchart illustrating one non-limiting example of a method for practicing the exemplary embodiments of this invention.

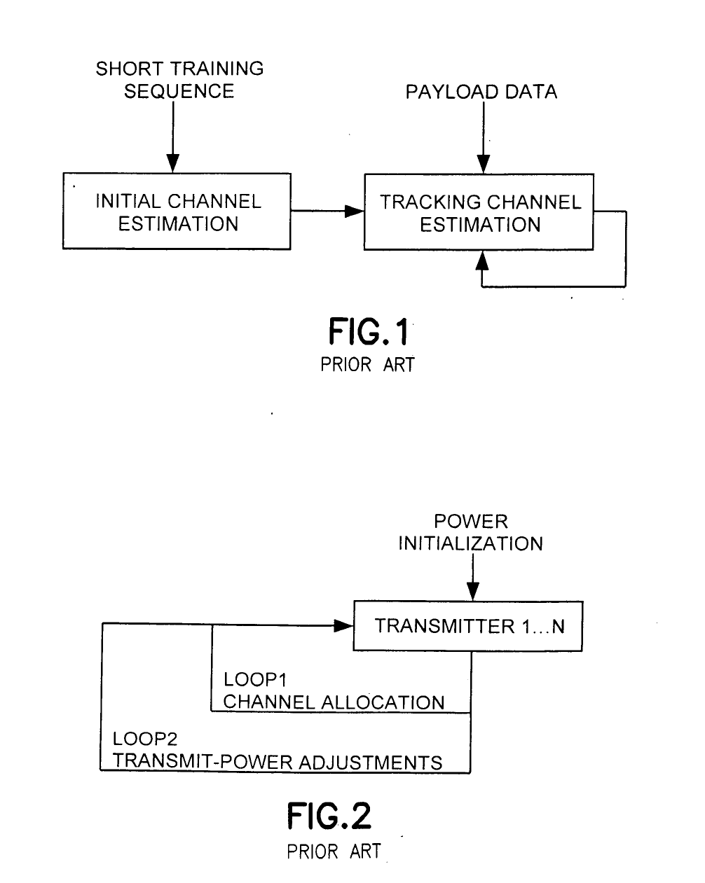

### DETAILED DESCRIPTION

The exemplary embodiments of the invention provide enhancements that enable a cognitive radio system to account for variable complexity in the receiver of the mobile terminal. This may be accomplished by: using different receiver algorithm sets for different channel properties, increasing the transmit-power to compensate for less complex receiver architecture, finding a free high quality channel for a lower complexity receiver, as non-limiting examples and as further described below.

As utilized herein, complexity refers to a relative measure of the attributes, schemes and techniques required for a given receiver to communicate with another device. For example, a low complexity receiver is unable to adequately communicate using a low quality channel or a low transmission power. In contrast, a high complexity receiver would be able to adequately communicate using the low quality channel or low transmit-power. As non-limiting examples, the attributes, schemes and techniques considered may comprise: coding rate, modulation scheme, transmit-power, channel quality, quality of service and access technique. Complexity may be a flexible measure, a static measure or both, as non-limiting examples. For example, complexity may correspond, in whole or in part, to: the load of the processor that runs the receiver algorithms, the number of different processors required to run all of the receiver algorithms within the necessary time (e.g., timeframe) and/or the number of data exchanges between different processors. As a further, non-limiting example, receiver complexity generally may be seen as the number of mathematical and logical operations per algorithm or per receiver.

Complexity may be determined by considering one or more of a variety of different aspects of the communication system and/or link (e.g., channel). Non-limiting examples of bases for determining complexity include: one or more measured channel qualities, channel selectivity (e.g., steepness of analog or digital filters), Info/Query (IQ) imbalances (e.g., a desire for a lower IQ imbalance corresponds to an increase in complexity) and linearity (e.g., the less non-linear the system should be distorted then the more linear the components should be corresponding to an increase in complexity).

Cognitive radio may be enhanced for low complexity (e.g., low power) receivers by introducing different algorithm sets that correspond to different channel properties (e.g., channel-state information). A suitable algorithm set can be selected based on the obtained channel properties.

FIG. 3 illustrates three exemplary algorithm sets that may be used for three different channel property determinations in accordance with aspects of the exemplary embodiments of the invention. In FIG. 3, channel-state information (CSI) is determined based on the signal input. Based on the determined CSI, a technology (e.g., an algorithm set) is chosen that has the best channel. Three algorithm sets A, B, C are shown, corresponding to low complexity (e.g., nearly ideal channel), medium complexity (e.g., time variant channel) and high complexity (e.g., strong interference, fast time-varying channel). As can be seen in FIG. 3, the characteristics, attributes and/or constituent algorithms employed may vary based on the channel properties.

Although the three algorithm sets A, B, C of FIG. 3 are identified based on the complexity of the signal from which the CSI is determined, in other embodiments the algorithm sets may be chosen based on other attributes, characteristics, measurements or determinations of, made of or based on one or more channel properties of the signal input. In further embodiments, a different number of algorithm sets may be available (e.g., two sets, four sets, five sets).

A cognitive radio system, particularly one similar to that shown in FIG. 2, may be enhanced by introducing a third loop to enable adjustments (e.g., of the channel allocation, of transmit-power) based on receiver complexity.

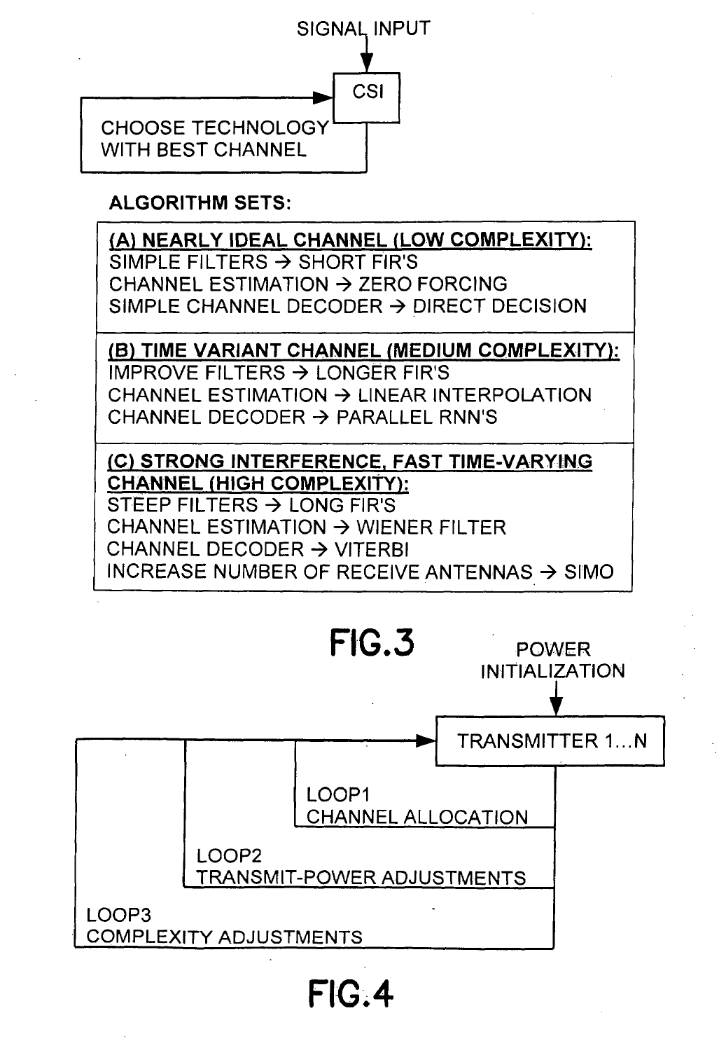

FIG. 4 shows an exemplary three-loop setup for a cognitive radio system in accordance with aspects of the exemplary embodiments of the invention. Similar to FIG. 2, after Power Initialization, a first, inner loop (Loop1) iterates for all operating transmitters. In Loop1, each transmitter allocates a number of channels (e.g., based on a Water-Filling approach; see Haykin1 at pp. 213-216, Section IX). After the bandwidth is allocated (Loop 1), the transmission systems are investigated in a second loop (Loop2) to determine if the transmit-power for the transmitter should be adjusted. For example, in Loop2, each transmitter may determine whether its actual data rate is exceeding, matching or undershooting the target data rate. If the actual data is exceeding or undershooting the target data rate, Loop2 adjusts the transmit-power of the respective transmitter in an attempt to match the actual data rate with the target data rate.

Unlike the system of FIG. 2, in the system of FIG. 4 there is an additional, third loop (Loop3) that operates after the previous two loops (Loop1 and Loop2). Loop3 makes adjustments (e.g., of the channel allocation, of the transmit-power) based on complexity. For example, in Loop3, one or more of the receivers may request or indicate a preference for a low (or lower) complexity approach. In response to such a request or indication, the system may try to accommodate the request or indication by modifying the channel allocation (e.g., new channel allocation or selection, exchanging available channels between different radios/receivers/transmitters) or modifying the transmit-power level of the corresponding receiver, as non-limiting examples.

In the system of FIG. 4, the third loop is optional. In other embodiments, the third loop may be mandatory. In further embodiments, the third loop may interact with other loops. As a non-limiting example, the third loop may cause the process to revisit one or more previous loops, for example, to reallocate the channels or modify the transmit-power in light of the desired low complexity. In other embodiments, the third loop may operate completely independent of other loops. In further embodiments, the functionality of the third loop may be integrated in one or more of the previous loops. As a non-limiting example, the functionality of the third loop may be integrated in the first loop of FIG. 4 such that the system first inquires whether a receiver prefers a low complexity approach and subsequently allocates channels in light of any such preference.

Although Loop2 of FIG. 4 is discussed as operating based on a comparison of the actual data rate with the target data rate, in other embodiments other criteria may be utilized to determine if the transmit-power should be adjusted for that transmitter.

While FIG. 4 illustrates a system comprising three loops (Loop1, Loop2 and Loop3), in other embodiments the system may comprise a different number of loops. Furthermore, in other embodiments the loops may be utilized for different purposes (e.g., to make adjustments based on different characteristics, criteria or preferences).

As noted above, two non-limiting, exemplary system properties that may be considered when enabling (e.g., acting on) a requested or indicated reduction of receiver complexity comprise transmit-power and channel selection. If a low complexity receiver is to be used, it may be desirable to increase the transmit-power or to select a high quality channel, as non-limiting examples.

Three non-limiting, exemplary implementations, numbered (1), (2) and (3), for achieving a reduction in receiver complexity are discussed below.

Increase Transmit-Power: If the transmit-power for a corresponding transmitter is increased (e.g., within Loop2), a less complex receiver architecture can be installed and/or utilized for the corresponding radio (e.g., receiver). Note that if a less complex architecture if used for one radio (i.e., the transmit-power for the one radio is increased), it may be necessary to concomitantly increase the complexity for one or more other radios (e.g., by decreasing the transmit-power for the one or more other radios). This may be performed in accordance with the Water Filling approach, as further described by Haykin1. However, should such a balancing be required, it is likely that the power reduction can be distributed over the other radios such that no one radio receives a significant reduction in transmit-power.

Receiver complexity reduction through transmit-power increase is generally not the preferred approach, at least without additional mechanisms. For example, if all of the cognitive radio receivers requested complexity reduction, it would be difficult, if not impossible, to accommodate all of the requests due to the necessary balancing (i.e., an increase in transmit-power generally necessitates a reduction elsewhere in the system, unless there are unused resources, for example). Thus, instead of the first implementation (1) or in addition to the first implementation (1), it is preferable to employ one of the other implementations (2) or (3) as discussed further below.

High Quality Channel Selection: A request or indication for reduced complexity (e.g., as made in Loop3) may incite a new channel allocation or reallocation of the channels (e.g., reactivation of Loop1). If the cognitive radio can find another, better-fitting, available (e.g., free) high quality channel for the corresponding radio (e.g., receiver), the low complexity request can be addressed without modifying (e.g., increasing) the transmit-power for the corresponding transmitter. If no high quality channel is available (e.g., free), it may be possible to reallocate the previously-allocated channels to accommodate the request. The second implementation may be preferable from an overall system perspective because less action is required from all of the cognitive radios (i.e., the channels are reallocated by one entity; the radios do not need to collectively modify transmit-power).

Low Complexity Parameter: A low complexity parameter may be utilized to account for low complexity requests or indications during channel allocation (Loop1) or transmit-power adjustment (Loop2). In such a manner, as a non-limiting example, Loop3 may not be included as a wholly separate loop. Instead, the functionality of Loop3 may be integrated into one or both of Loop1 and Loop2. For example, each channel selection process and/or each transmit-power adjustment would be informed beforehand whether the corresponding receiver is requesting or indicating a preference for low complexity support. If the low complexity option is requested or indicated by one or more receivers (e.g., using the low complexity parameter), Loop1 and/or Loop2 can account for the request/indication during the operation of the respective loop. In this implementation, the selection process (e.g., operation) of one or both loops (Loop1 and Loop2) may be more complex. However, the increased loop complexity is offset by the fact that the third loop (Loop3) is no longer included as a separate loop (e.g., iteration).

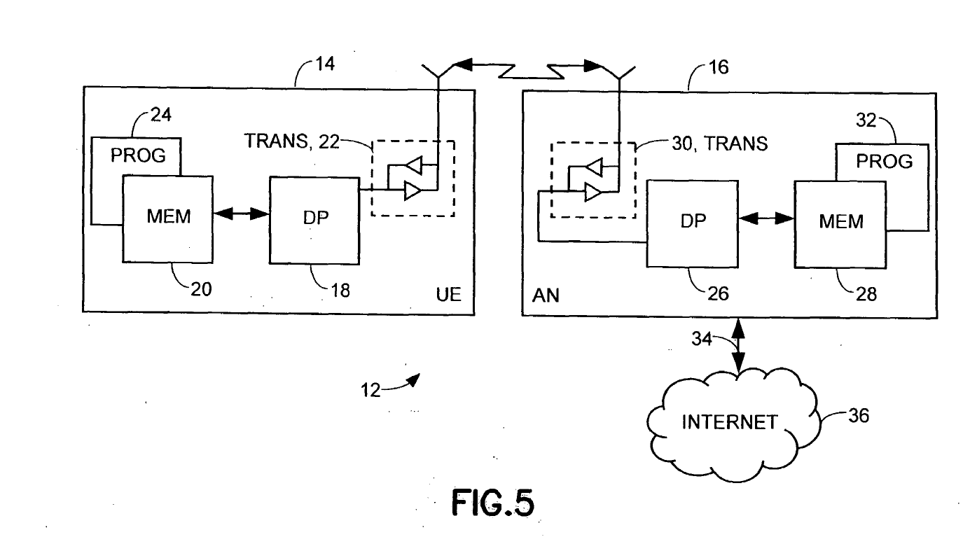

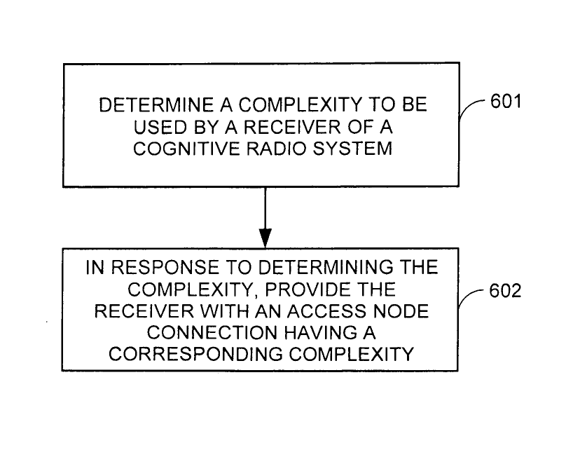

Reference is made to FIG. 5 for illustrating a simplified block diagram of various electronic devices that are suitable for use in practicing the exemplary embodiments of this invention. In FIG. 5, a wireless network 12 is adapted for communication with a user equipment (UE) 14 via an access node (AN) 16. The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication.

The AN 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, cellular phones, personal digital assistants (PDAs) having wireless communication capabilities, computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as units or terminals that incorporate combinations of such functions. The UE 14 may comprise a mobile terminal or a stationary terminal, as non-limiting examples.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

As can be seen, the exemplary embodiments of the invention provide enhancements that enable a cognitive radio system to account for variable complexity in the receiver of the mobile terminal. In some embodiments, the inclusion of a third loop (e.g., Loop3 of FIG. 4) or functionality corresponding to the third loop, as described above, is optional and may not be supported by every cognitive radio or cognitive radio system. Furthermore, in some embodiments, the hardware and/or software responsible for complexity reduction may be located in either the mobile terminal or the access node (e.g., base station). This enables additional flexibility when considering a preferred implementation. As a non-limiting example, aspects of the exemplary embodiments of the invention may be implemented and/or achieved on any suitable protocol layer, including protocol layers higher than the Physical Layer (PHY). As non-limiting examples, aspects of the exemplary embodiments of the invention may be implemented in the PHY (Layer 1), the Medium Access Control Layer (MAC, Layer 2) or the Radio Network Layer (RNL, Layer 3).

In one non-limiting, exemplary embodiment, and as illustrated in FIG. 6, a method includes: determining a complexity to be used by a receiver of a cognitive radio system (601); and, in response to determining the complexity, providing the receiver with an access node connection having a corresponding complexity (602).

In other embodiments, determining the complexity comprises: obtaining at least one channel property; based on the obtained at least one channel property, selecting an algorithm set from a plurality of algorithm sets, wherein each algorithm set comprises at least one attribute and/or algorithm to be used for the access node connection; and utilizing the selected algorithm set for the access node connection. In further embodiments, providing the access node connection comprises adjusting a resource allocation of the receiver. In other embodiments, adjusting the resource allocation comprises allocating the receiver a high quality channel. In further embodiments, adjusting the resource allocation comprises reallocating a plurality of channels among a plurality of receivers such that the receiver is allocated a higher quality channel. In other embodiments, adjusting the resource allocation comprises increasing a transmit-power of a transmitter corresponding to the access node connection with the receiver. In other embodiments, the receiver comprises a mobile receiver.

In another non-limiting, exemplary embodiment, a computer program product comprises program instructions embodied on a tangible computer-readable medium. Execution of the program instructions results in operations comprising: determining a complexity to be used by a receiver of a cognitive radio system; and, in response to determining the complexity, providing the receiver with an access node connection having a corresponding complexity.

In another non-limiting, exemplary embodiment, an electronic device comprises: a data processor configured: to determine a complexity to be used by a receiver of a cognitive radio system; and, in response to determining the complexity, to provide the receiver with an access node connection having a corresponding complexity (602).

In other embodiments, the electronic device comprises the receiver. In further embodiments, the electronic device comprises the access node. In other embodiments, the electronic device comprises a mobile receiver. In further embodiments, the electronic device further comprises a transceiver coupled to the data processor, wherein the transceiver is configured to wirelessly communicate with another electronic device.

It should be appreciated that the exemplary embodiments of this invention, as described herein, may be used to advantage in any wireless communication system that supports cognitive radios and/or comprises a plurality of cognitive radios. As non-limiting examples, aspects of the exemplary embodiments of the invention may be implemented in a CDMA, OFDMA, UTRAN or E-UTRAN wireless communication system.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

Generally, various exemplary embodiments of the invention can be implemented in different mediums, such as software, hardware, logic, special purpose circuits or any combination thereof. As a non-limiting example, some aspects may be implemented in software which may be run on a computing device, while other aspects may be implemented in hardware.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

I claim:

1. A method comprising:
determining a complexity to be used for a receiver of a cognitive radio; and
changing a connection between an access node and the receiver to a connection having a corresponding complexity.

2. The method of claim 1, executed by the cognitive radio, wherein determining the complexity comprises:
obtaining at least one channel property;
based on the at least one channel property, selecting an algorithm set from a plurality of algorithm sets representing varying levels of receiver complexity, said plurality of algorithm sets stored in a local memory of the cognitive radio; and
utilizing the selected algorithm set for the changed connection having the corresponding complexity.

3. The method of claim 2, wherein each of the algorithm sets comprise at least one attribute selected from the group: coding rate, modulation scheme, transmit-power, channel quality, quality of service and access technique.

4. The method of claim 1, executed by the access node wherein changing the connection between the access node and the receiver to the connection having the corresponding complexity comprises the access node adjusting a resource allocation of the receiver to a high quality channel.

5. The method of claim 4, wherein adjusting the resource allocation comprises adjusting resource allocations among a plurality of receivers such that the said receiver is given a resource allocation for the high quality channel.

6. The method of claim 1, executed by the access node and wherein determining the complexity to be used for the receiver of the cognitive radio comprises receiving from a transmitter of a cognitive radio a request to reduce receiver complexity.

7. The method of claim 1 executed by the access node, the method further comprising:
executing a first loop in which resources are allocated to a plurality of cognitive radios; and
executing a second loop in which transmit power of the said cognitive radio is adjusted.

8. The method of claim 7, wherein determining the complexity to be used for the receiver of the cognitive radio is based on the adjusted transmit power.

9. The method of claim 8, wherein the transmit power is adjusted so as to match actual data rate to a target data rate.

10. The method of claim 7, wherein changing the connection comprises re-executing the first loop so as to re-allocate resources to the plurality of cognitive radios, and wherein the changed connection comprises a free channel not allocated in the first-said execution of the first loop.

11. The method of claim 7, wherein determining the complexity to be used for the receiver of the cognitive radio comprises receiving from a transmitter of a cognitive radio a request to reduce receiver complexity, and wherein the first loop is executed so as to satisfy the received request.

12. An apparatus comprising a processor and a transmitter and a receiver that are together configured to determine a complexity to be used for the receiver and to change to a connection between an access node and the receiver to a connection having a corresponding complexity.

13. The apparatus of claim 12, wherein the apparatus comprises a cognitive radio, and the processor is configured to determine the complexity by:
obtaining at least one channel property from the receiver;
based on the at least one channel property, selecting an algorithm set from a plurality of algorithm sets representing varying levels of receiver complexity, said plurality of algorithm sets stored in a local memory of the cognitive radio; and
utilizing the selected algorithm set for the access node connection having the corresponding complexity.

14. The apparatus of claim 13, wherein each of the algorithm sets comprise at least one attribute selected from the group: coding rate, modulation scheme, transmit-power, channel quality, quality of service and access technique.

15. The apparatus of claim 12, wherein the apparatus comprises the access node, wherein the connection between the access node and the receiver is changed to a connection having the corresponding complexity by the access node adjusting a resource allocation of the receiver to a high quality channel.

16. The apparatus of claim 15, wherein the access node adjusts resource allocations among a plurality of receivers such that the said receiver is given a resource allocation for the high quality channel.

17. The apparatus of claim 12, wherein the complexity to be used for the receiver of the cognitive radio is determined by an increase to transmit power of a transmitter on a connection between the access node and the transmitter and the connection is changed to a lower complexity connection between the access node and the receiver.

18. The apparatus of claim 12, wherein the apparatus comprises the access node, wherein the processor further is configured to:
execute a first loop in which resources are allocated to a plurality of cognitive radios; and
execute a second loop in which transmit power of the said cognitive radio is adjusted.

19. The apparatus of claim 18, wherein the processor is configured to determine the complexity to be used for the receiver of the cognitive radio based on the adjusted transmit power.

20. The apparatus of claim 19, wherein the transmit power is adjusted so as to match actual data rate to a target data rate.

21. The apparatus of claim 18, wherein the processor is configured to change the connection by re-executing the first loop so as to re-allocate resources to the plurality of cognitive radios, and wherein the changed connection comprises a free channel not allocated in the first-said execution of the first loop.

22. The apparatus of claim 18, wherein the processor is configured to determine the complexity to be used for the receiver of the cognitive radio from a request from a transmitter of a cognitive radio to reduce receiver complexity, and wherein the processor executes the first loop so as to satisfy the received request.

23. A computer readable medium embodying program instructions executable by a processor for executing actions directed toward determining a complexity to be used by a receiver of a cognitive radio system, the actions comprising:
determining a complexity to be used for a receiver of a cognitive radio; and
changing a connection between an access node and the receiver to a connection having a corresponding complexity.

24. The computer readable medium of claim 23 embodied within a cognitive radio, wherein determining the complexity comprises:
obtaining at least one channel property;
based on the at least one channel property, selecting an algorithm set from a plurality of algorithm sets representing varying levels of receiver complexity, said plurality of algorithm sets stored in a local memory of the cognitive radio; and
utilizing the selected algorithm set for the changed connection having the corresponding complexity.

25. The computer readable medium of claim 23 embodied in the access node, the actions further comprising:
executing a first loop in which resources are allocated to a plurality of cognitive radios; and
executing a second loop in which transmit power of the said cognitive radio is adjusted.

26. The computer readable medium of claim 25, wherein changing the connection comprises re-executing the first loop so as to re-allocate resources to the plurality of cognitive radios, and wherein the changed connection comprises a free channel not allocated in the first-said execution of the first loop.

27. The computer readable medium of claim 25 wherein determining the complexity to be used for the receiver of the cognitive radio comprises receiving from a transmitter of a cognitive radio a request to reduce receiver complexity, and wherein the first loop is executed so as to satisfy the received request.

28. An apparatus comprising:
processing means and radio means that together are for determining a complexity to be used for a cognitive radio receiver and for changing to a connection between an access node and the receiver to a connection having a corresponding complexity.

29. The apparatus of claim 28, wherein the processing means comprises a processor, and the radio means comprises a transmitter and a receiver.
